(19) United States
(12) Patent Application Publication
(10) Pub. No.: US 2026/0309550 A1
(43) Pub. Date: Oct. 8, 2026

(54) MEASUREMENT DEVICE WITH FRONT LIT ARCHITECTURE

(71) Applicant: Himax Display, Inc., Tainan City (TW)

(72) Inventors: Wen-Hsu Chen, Tainan City (TW); Yuet Wing LI, Tainan City (TW)

(73) Assignee: Himax Display, Inc., Tainan City (TW)

(21) Appl. No.: 19/442,944

(22) Filed: Jan. 7, 2026

Related U.S. Application Data
(60) Provisional application No. 63/784,952, filed on Apr. 7, 2025.

(51) Int. Cl. G01J 5/10; G01J 5/08

(52) U.S. Cl. CPC G01J 5/10; G01J 5/0814

(57) ABSTRACT

A measurement device with front lit (FL) architecture includes a sensor, a mirror-angle to light converter (ALC) and a receiver. The sensor can be configured to convert a physical signal into a sensor output signal. The ALC can be configured to control a mirror angle of at least one mirror within the ALC according to the sensor output signal, in order to redirect a light beam from the FL architecture with the at least one mirror, wherein the FL architecture is integrated into the ALC. The receiver can be configured to receive the redirected light beam as a light spot on a detection area of the receiver, wherein a displacement of the light spot is used as a measurement result for indicating a magnitude of the physical signal.

### CROSS REFERENCE TO RELATED APPLICATIONS

This application claims the benefit of U.S. Provisional Application No. 63/784,952, filed on Apr. 7, 2025. The content of the application is incorporated herein by reference.

### BACKGROUND OF THE INVENTION

### 1. Field of the Invention

The present invention is related to measurement, and more particularly, to a measurement device with front lit (FL) architecture.

### 2. Description of the Prior Art

According to the related art, measurement of the environment may be carried out with a general professional sensor. For example, the general professional sensor may have a large size, and it may be difficult to integrate the general professional sensor into a compact system, leading to increased design complexity and space constraints. In addition, the general professional sensor may be very expensive. Because of its high cost, such a sensor significantly raises the overall product expense, limiting its feasibility for cost-sensitive applications. Thus, a novel architecture is needed for solving the problems without introducing any side effect or in a way that is less likely to introduce a side effect.

### SUMMARY OF THE INVENTION

It is an objective of the present invention to provide a measurement device with FL architecture, in order to solve the above-mentioned problems.

At least one embodiment of the present invention provides a measurement device with FL architecture, where the measurement device comprises a sensor, a mirror-angle to light converter (ALC) and a receiver. The sensor can be configured to convert a physical signal into a sensor output signal. The ALC can be configured to control a mirror angle of at least one mirror within the ALC according to the sensor output signal, in order to redirect a light beam from the FL architecture with the at least one mirror, wherein the FL architecture is integrated into the ALC. The receiver can be configured to receive the redirected light beam as a light spot on a detection area of the receiver, wherein a displacement of the light spot is used as a measurement result for indicating a magnitude of the physical signal.

It is an advantage of the present invention that the proposed device such as the measurement device with the FL architecture can operate reliably under various conditions. Furthermore, the proposed device can be lightweight, enabling easy integration into compact systems and thereby reducing design complexity and space constraints. In addition, the proposed device is capable of reflecting visible light, which can be detected using a visible light sensor-a component that is less expensive than a general professional sensor. Consequently, the overall cost can be reduced, increasing feasibility for cost-sensitive applications.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a measurement device with FL architecture according to an embodiment of the present invention.

FIG. 2 illustrates some implementation details of the ALC within the measurement device shown in FIG. 1 according to an embodiment of the present invention.

FIG. 3 illustrates a sensor readout stack using the FL architecture within the measurement device shown in FIG. 1 according to an embodiment of the present invention.

FIG. 4 illustrates some projection results of the redirected light beam in the measurement device shown in FIG. 1 for a first case that the light-guide thickness is set as 0.3 millimeters (mm) according to an embodiment of the present invention.

FIG. 5 illustrates some projection results of the redirected light beam in the measurement device shown in FIG. 1 for a second case that the light-guide thickness is set as 0.7 mm according to an embodiment of the present invention.

FIG. 6A illustrates some projection results of the redirected light beam in the measurement device shown in FIG. 1 for a third case that the input cone varies within a predetermined range according to an embodiment of the present invention.

FIG. 6B illustrates some other projection results of the redirected light beam in the measurement device shown in FIG. 1 for the third case that the input cone varies within the predetermined range.

FIG. 7A illustrates the light path and associated parameters of the measurement device shown in FIG. 1 at one of multiple temperatures according to an embodiment of the present invention.

FIG. 7B illustrates the light path and associated parameters of the measurement device shown in FIG. 1 at another of the multiple temperatures.

### DETAILED DESCRIPTION

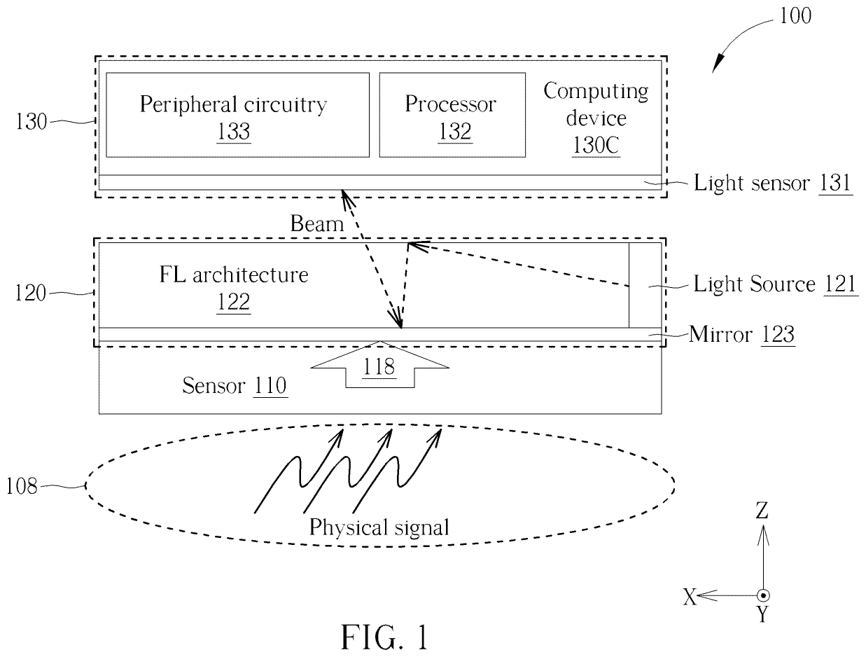

FIG. 1 is a diagram of a measurement device 100 with FL architecture 122 according to an embodiment of the present invention. The measurement device 100 comprises a sensor 110, an ALC 120 and a receiver 130, where the FL architecture 122 can be integrated into the ALC 120. The ALC 120 comprises a light source 121, the FL architecture 122, and at least one mirror (e.g., one or more mirrors), collectively referred to as the mirror 123. In addition, the receiver 130 comprises a computing device 130C and a light sensor 131 that are coupled to each other, and the computing device 130C comprises a processor 132 and a peripheral circuitry 133. For example, the sensor 110 can be configured to convert a physical signal 108 into a sensor output signal 118. The ALC 120 can be configured to control a mirror angle of the aforementioned at least one mirror such as the mirror 123 within the ALC 120 according to the sensor output signal 118, in order to redirect a light beam from the FL architecture 122 with the aforementioned at least one mirror such as the mirror 123. The receiver 130 can be configured to receive the redirected light beam (labeled “Beam” for brevity) as a light spot on a detection area of the receiver 130, and more particularly, detect the projection of the redirected light beam on the detection area as this light spot, in order to use a displacement of the light spot as a measurement result for indicating a magnitude of the physical signal 108.

The measurement device 100 can be configured to measure a change of the physical signal 108, and to output the measurement result, for indicating of the measured change with variation of the measurement result. For example, when the physical signal 108 carries a thermal stimulus, the measurement device 100 can act as a thermal sensor, but the present invention is not limited thereto. The sensor output signal 118 may represent an electrical signal, and the physical signal 108 may carry at least one physical stimulus (e.g., one or more physical stimuli), where the aforementioned at least one physical stimulus may comprise one or a combination of a thermal stimulus, a radiative stimulus, a pressure stimulus, and an acoustic stimulus. Regarding the ALC 120, the light source 121 can be configured to generate light, the FL architecture 122 can be configured to receive the light from the light source 121 to generate the light beam, and the aforementioned at least one mirror such as the mirror 123 can be configured to reflect the light beam to redirect the light beam. In addition, a first surface among two opposite surfaces of the FL architecture 122 can be configured as facing toward the aforementioned at least one mirror such as the mirror 123, allowing the light beam to be redirected by the aforementioned at least one mirror such as the mirror 123, and a second surface among the two opposite surfaces can be configured as facing toward the receiver 130, allowing the redirected light beam to reach the detection area of the receiver 130. Taking the coordinate system of the X-axis, the Y-axis and the Z-axis shown in FIG. 1 as an example, the lower surface and the upper surface of the FL architecture 122 that are perpendicular to the Z-axis can act as the two opposite surfaces, and more particularly, can act as the first surface and the second surface, respectively. Additionally, the light sensor 131 can be configured to perform light sensing for the receiver 130, where the detection area of the receiver 130 represents the sensing area of the light sensor 131. The computing device 130C (in particular, the processor 132 therein) can be configured to perform computing (including but not limited to calculation) for the receiver 130 to detect the displacement of the light spot.

As the FL architecture 122 such as the light guide is typically lightweight, the measurement device 100 can be lightweight, enabling easy integration into compact systems and thereby reducing design complexity and space constraints. For example, the light from the light source 121 may represent visible light, the light beam may represent a visible light beam, and the light sensor 131 may represent a visible light sensor. The FL architecture 122 such as the light guide can reflect the visible light to generate the visible light beam. After the light beam such as the visible light beam is redirected as the redirected visible light beam, it can be detected using the visible light sensor-a component that is less expensive than a general professional sensor. Consequently, the overall cost can be reduced, increasing feasibility for cost-sensitive applications.

In the above embodiment, the FL architecture 122 can be implemented by way of a light guide, the aforementioned at least one mirror such as the mirror 123 can be implemented by way of micro-electro-mechanical systems (MEMS) technology (or “the MEMS”), the light sensor 131 can be implemented by way of an image sensor having a charge-coupled device (CCD) or complementary metal-oxide semiconductor (CMOS) array, and the peripheral circuitry 133 can be implemented by way of a power management unit (PMU), a clock, an analog-to-digital converter (ADC), etc. This is for illustrative purposes only, and is not meant to be a limitation of the present invention. According to some embodiments, the architecture of the measurement device 100 as well as the components therein may vary. In addition, the FL architecture 122 such as the light guide can be configured to inject the light beam such as the visible light beam into the mirror 123 (e.g., the microstructure mirror), allowing the mirror 123 to reflect the light beam such as the visible light beam toward the receiver 130, for generating the light spots with different displacements.

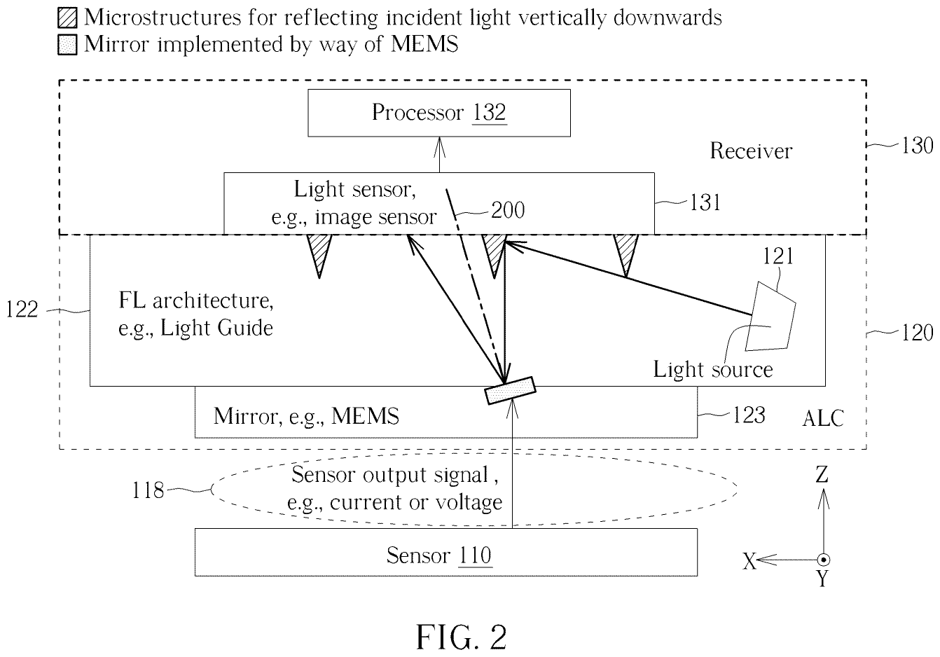

FIG. 2 illustrates some implementation details of the ALC 120 within the measurement device 100 shown in FIG. 1 according to an embodiment of the present invention. The FL architecture 122 such as the light guide can be configured to collect the light from the light source 121 as the light beam, for being redirected with the aforementioned at least one mirror such as the mirror 123, and more particularly, to comprise microstructures for reflecting incident light vertically downwards, for example, in the negative Z-axis direction as shown in FIG. 2. The mirror 123 can be configured to comprise the mirrors implemented by way of MEMS for reflecting the light beam directed toward the negative Z-axis, with the reflection following the Law of Reflection, to generate the redirected light beam. Regarding the Law of Reflection, the angle of incidence equals the angle of reflection, with both angles measured from the normal (e.g., a line 200 perpendicular to the surface). As shown in FIG. 2, some sub-components of the FL architecture 122 and the mirror 123, such as the microstructures positioned on the upper surface of the FL architecture 122 and the mirrors implemented by way of MEMS within the mirror 123, may be illustrated as being much larger than their actual sizes for better comprehension, but the present invention is not limited thereto. These sub-components of the FL architecture 122 and the mirror 123 are typically very tiny. In addition, the sensor output signal 118 can be transmitted as a current signal or a voltage signal (labeled “current or voltage” for brevity) from the sensor 110 to the mirror 123.

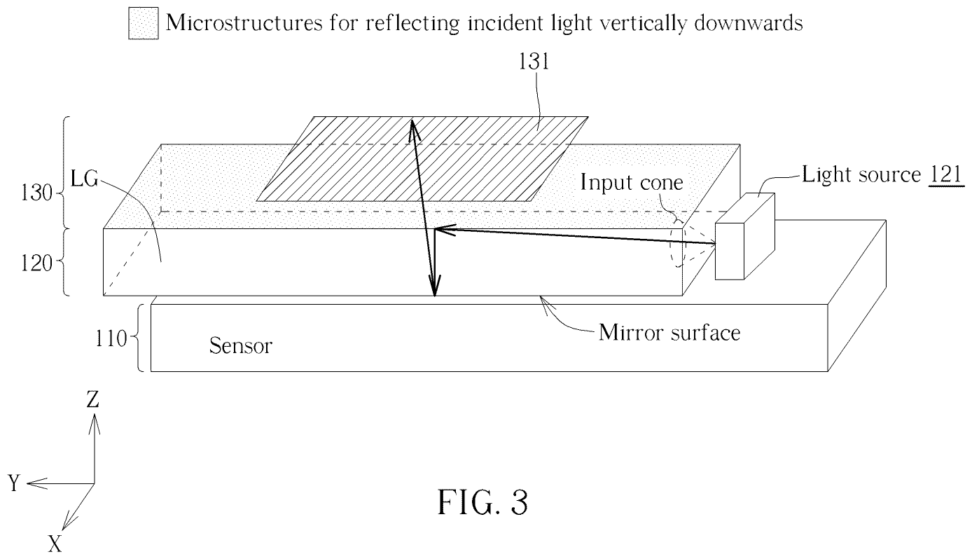

FIG. 3 illustrates a sensor readout stack using the FL architecture 122 within the measurement device 100 shown in FIG. 1 according to an embodiment of the present invention. The light source 121 can generate the light to produce an input beam under a specific cone angle (referred to as the input cone hereinafter), for being input into the FL architecture 122 such as the light guide (labeled “LG” for brevity) within the ALC 120. The microstructures for reflecting incident light vertically downwards may be illustrated with shading since they are very tiny. The mirrors implemented by way of MEMS may be positioned below the lower surface of the FL architecture 122 (e.g., the light guide), at the bottom of the ALC 120, for acting as an adjustable microscopic mirror surface (labeled “Mirror surface” for brevity). For brevity, similar descriptions for this embodiment are not repeated in detail here.

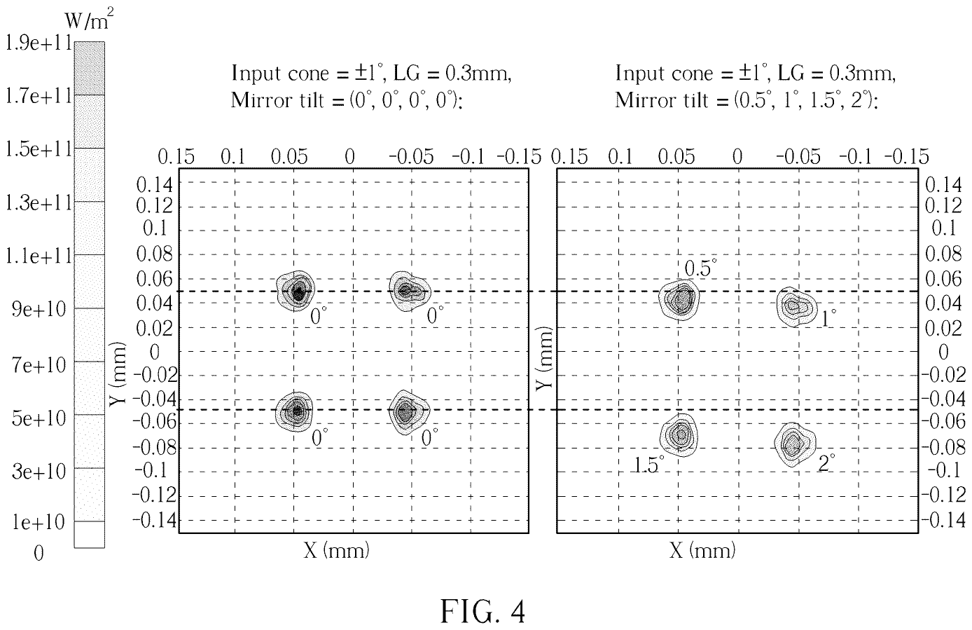

FIG. 4 illustrates some projection results of the redirected light beam in the measurement device 100 shown in FIG. 1 for a first case that the light-guide thickness is set as 0.3 mm according to an embodiment of the present invention, where the projection results may have been rearranged, for example, by rotating them with respect to the Z-axis and shifting them to grid locations, for indicating the displacement with respect to the mirror tilt. The bright spot may be displaced due to the mirror tilting underneath. The FL system can function and the sensitivity depends on the LG thickness, the input cone angle (i.e., the input cone mentioned above), and the sensor resolution (i.e., the resolution of the light sensor 131 such as the CCD/CMOS image sensor with the CCD/CMOS array). For example, assuming that the input cone is equal to (or within the range of)=1°, for the first case that the light-guide thickness is set as 0.3 mm (labeled “LG=0.3 mm” for brevity), when the mirror tilt changes from (0°, 0°, 0°, 0°) to (0.5°, 1°, 1.5°, 2°), respectively, the measurement device 100 can detect the displacement of the light spot (e.g., the projection results), respectively, as illustrated with the changes from the locations of the projection results shown in the left half part of FIG. 4 to that shown in the right half part of FIG. 4, but the present invention is not limited thereto. According to some embodiments, the light spot such as the projection results may vary.

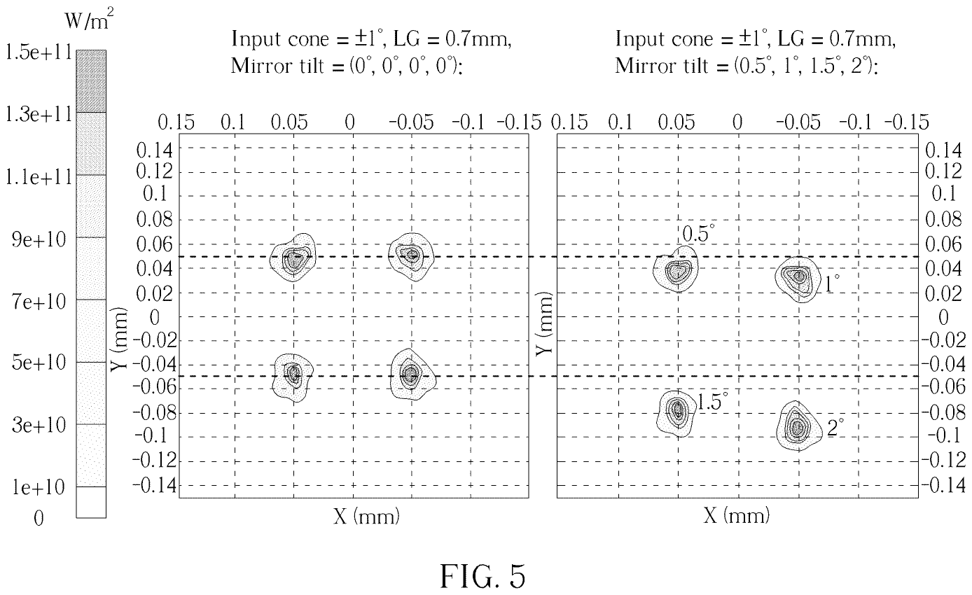

FIG. 5 illustrates some projection results of the redirected light beam in the measurement device 100 shown in FIG. 1 for a second case that the light-guide thickness is set as 0.7 mm according to an embodiment of the present invention, where the projection results may have been rearranged, for example, by rotating them with respect to the Z-axis and shifting them to grid locations, for indicating the displacement with respect to the mirror tilt. Similar to the first case that the light-guide thickness is set as 0.3 mm, the light spot displaced due to the mirror tilting underneath in the second case. As the thickness of the light-guide increases, a longer spot displacement may be found. For example, assuming that the input cone is equal to (or within the range of) ±1°, for the second case that the light-guide thickness is set as 0.7 mm (labeled “LG=0.7 mm” for brevity), when the mirror tilt changes from (0°, 0°, 0°, 0°) to (0.5°, 1°, 1.5°, 2°), respectively, the measurement device 100 can detect the displacement of the light spot (e.g., the projection results), respectively, as illustrated with the changes from the locations of the projection results shown in the left half part of FIG. 5 to that shown in the right half part of FIG. 5, but the present invention is not limited thereto. According to some embodiments, the light spot such as the projection results may vary.

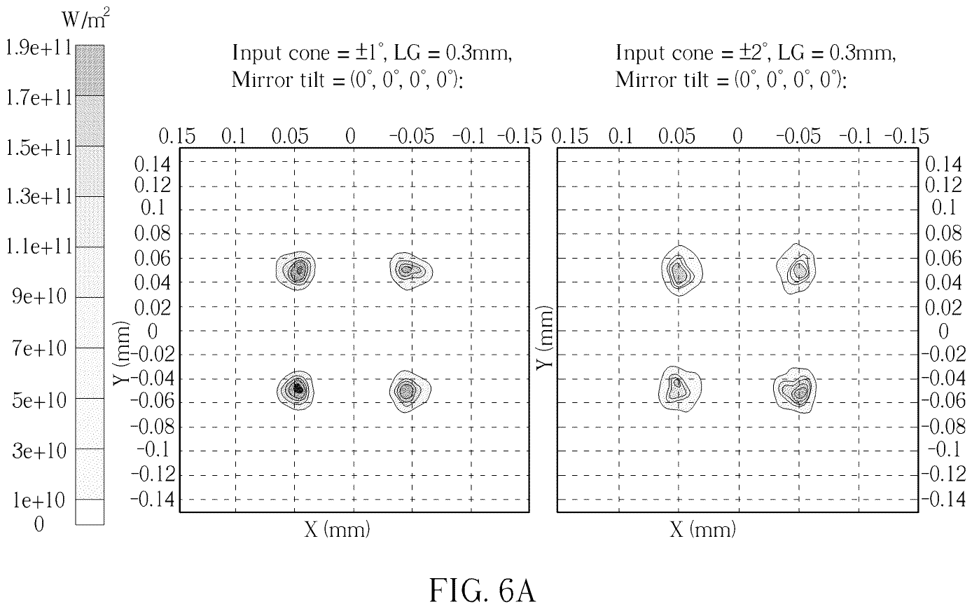

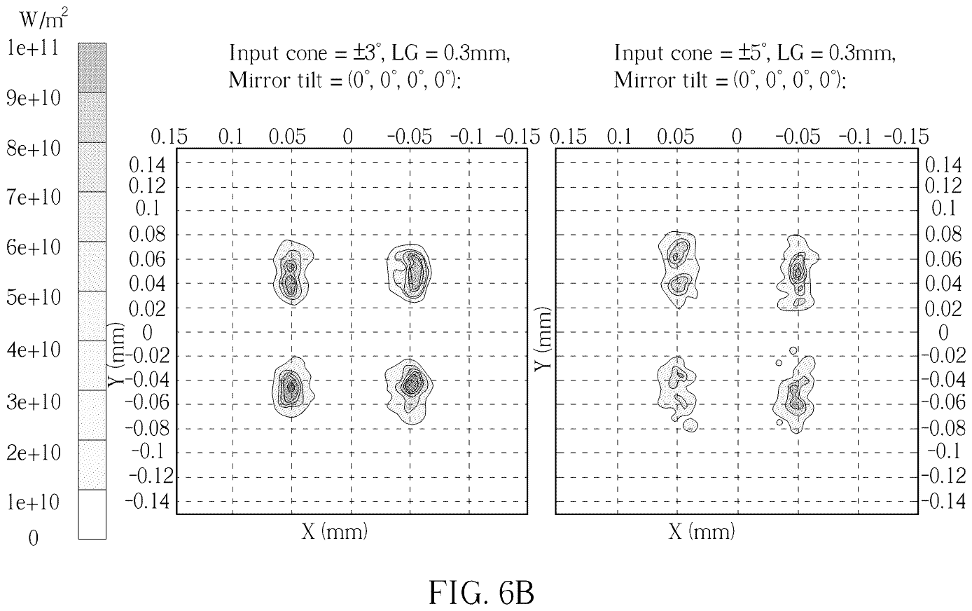

FIG. 6A and FIG. 6B illustrate some projection results of the redirected light beam in the measurement device 100 shown in FIG. 1 for a third case that the input cone varies within a predetermined range according to an embodiment of the present invention, where the projection results may have been rearranged, for example, by rotating them with respect to the Z-axis and shifting them to grid locations, for indicating the variation of the light spot (or the size and/or the shape thereof) with respect to the input cone. The predetermined range can be equal to the range of ±2°, or any other range as long as the implementation of the present invention will not be hindered. For example, implementing with an input cone greater than +2° is doable, but it may depend on the etendue (or étendue) and system efficiency. For example, assuming that the light-guide thickness is set as 0.3 mm (labeled “LG=0.3 mm” for brevity) and the mirror tilt is set as (0°, 0°, 0°, 0°), respectively, when the input cone is equal to (or within the range of) the ranges of ±1°, ±2°, ±3° and ±5°, respectively, the measurement device 100 can detect the light spot such as the projection results as shown in FIG. 6A to FIG. 6B, respectively, but the present invention is not limited thereto. According to some embodiments, the light spot such as the projection results may vary.

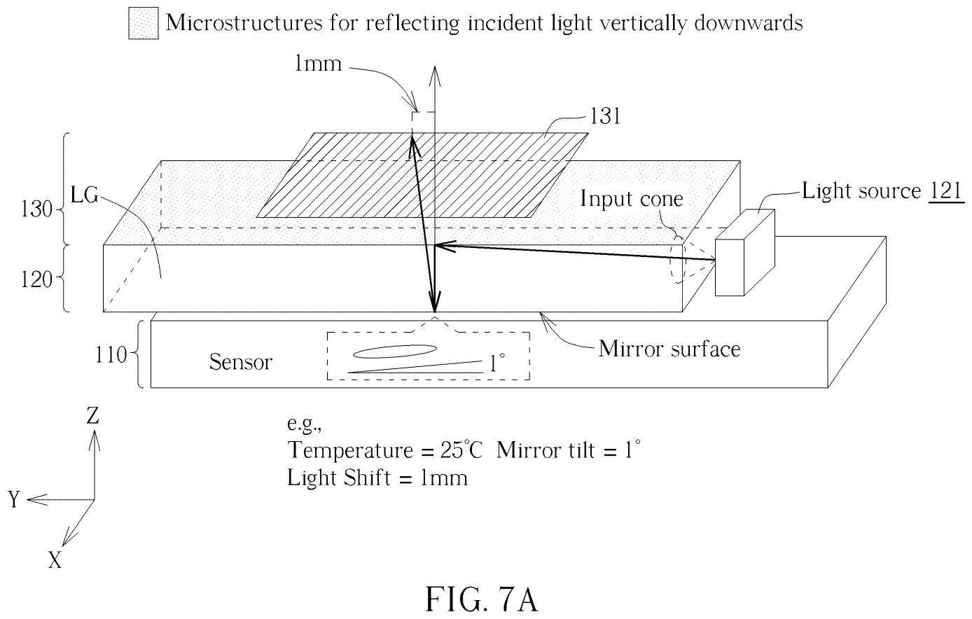

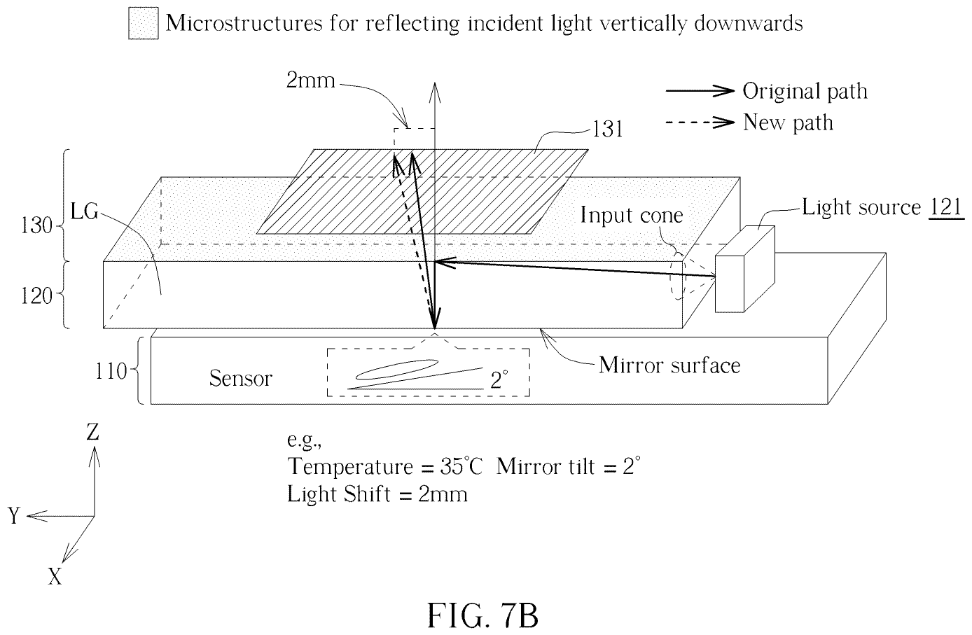

FIG. 7A and FIG. 7B illustrate the light paths and associated parameters of the measurement device 100 shown in FIG. 1 at multiple temperatures according to an embodiment of the present invention. For example, when the temperature is equal to 25 degrees Celsius (° C.), the mirror tilt can be equal to 1°, and the light shift such as the displacement can be equal to 1 mm. In addition, when the temperature is equal to 35° C., the mirror tilt can be equal to 2°, and the light shift such as the displacement can be equal to 2 mm, where the light path may change from the original path such as that shown in FIG. 7A to the new path as shown in FIG. 7B.

TABLE 1

| Temperature (° C.) | Mirror tilt (°) | Light shift (mm) |
|---|---|---|
| 20 | 0.5 | 0.5 |
| 25 | 1.0 | 1.0 |
| 30 | 1.5 | 1.5 |
| 35 | 2.0 | 2.0 |

Table 1 illustrates an example of the relationships between the temperature, the mirror tilt, and the light shift such as the displacement, but the present invention is not limited thereto. According to some embodiments, the temperature, the mirror tilt, the light shift, and/or the relationships between them may vary.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A measurement device with front lit (FL) architecture, comprising:
a sensor, configured to convert a physical signal into a sensor output signal;
a mirror-angle to light converter (ALC), configured to control a mirror angle of at least one mirror within the ALC according to the sensor output signal, in order to redirect a light beam from the FL architecture with the at least one mirror, wherein the FL architecture is integrated into the ALC; and
a receiver, configured to receive the redirected light beam as a light spot on a detection area of the receiver, wherein a displacement of the light spot is used as a measurement result for indicating a magnitude of the physical signal.

2. The measurement device of claim 1, wherein the sensor output signal represents an electrical signal, and the physical signal carries at least one physical stimulus, wherein the at least one physical stimulus comprises one or a combination of a thermal stimulus, a radiative stimulus, a pressure stimulus, and an acoustic stimulus.

3. The measurement device of claim 1, wherein the measurement device is configured to measure a change of the physical signal, and to output the measurement result, for indicating of the measured change with variation of the measurement result.

4. The measurement device of claim 1, wherein the ALC comprises:
a light source, configured to generate light;
the FL architecture, configured to receive the light from the light source to generate the light beam; and
the at least one mirror, configured to reflect the light beam to redirect the light beam.

5. The measurement device of claim 1, wherein the FL architecture is implemented by way of a light guide.

6. The measurement device of claim 1, wherein a first surface among two opposite surfaces of the FL architecture is configured as facing toward the at least one mirror, allowing the light beam to be redirected by the at least one mirror, and a second surface among the two opposite surfaces is configured as facing toward the receiver, allowing the redirected light beam to reach the detection area of the receiver.

7. The measurement device of claim 1, wherein the at least one mirror is implemented by way of micro-electro-mechanical systems (MEMS) technology.

8. The measurement device of claim 1, wherein the receiver comprises:
a light sensor, configured to perform light sensing, wherein the detection area represents a sensing area of the light sensor; and
a computing device, coupled to the light sensor, configured to perform computing for the receiver to detect the displacement of the light spot.

9. The measurement device of claim 8, wherein the light beam represents a visible light beam, and the light sensor represents a visible light sensor.

10. The measurement device of claim 1, wherein the FL architecture is configured to collect light from a light source as the light beam, for being redirected with the at least one mirror.
